(19) United States
(12) Patent Application Publication
(10) Pub. No.: US 2024/0074423 A1
(43) Pub. Date: Mar. 7, 2024

(54) Insect Seizing Bin Device And Method

(71) Applicant: Josh Adams, Stinnett, TX (US)

(72) Inventor: Josh Adams, Stinnett, TX (US)

(21) Appl. No.: 17/902,847

(22) Filed: Sep. 4, 2022

(51) Int. Cl. A01M 1/16; A01M 1/24; B65F 1/16

(52) U.S. Cl. CPC A01M 1/165; A01M 1/24; B65F 1/16; A01M 2200/012; B65F 2001/1653

(57) ABSTRACT

An insect seizing bin device and method for snatching insects for removal includes a band. The band includes a front surface, a back surface, a top surface and a bottom surface. The band is a supple material being bendable. A first fold line is positioned near the top surface of the band. The first fold line positions a first fold portion perpendicular to the back surface of the band. Additionally, a second fold line is positioned near to the first fold line of the band. The second fold line positions a second fold portion perpendicular to the back surface of the band and positioning the first fold portion parallel to the back surface the band. A strip is positioned on the front surface of the band. The strip is an adhesive material being retaining a plurality of insects upon the strip by physical contact.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to insect seizing device and more particularly pertains to a new insect seizing device for snatching insects for removal.

### (2) Description of Related Art Including Information Disclosed Under 37 CFR 1.97 and 1.98

The prior art relates to insect seizing devices. The prior art includes a variety of insect seizing devices using an adhesive material to snatch the insects prior to removal. Furthermore, the prior art relates to a variety of insect seizing devices configured for use in a trash bin. Known prior art lacks an insect seizing device configured for snatching insects for removal from a trash bin by the use of an adhesive material.

### BRIEF SUMMARY OF THE INVENTION

An embodiment of the disclosure meets the needs presented above by generally comprising a band. The band has a rectangular shape. The band has a front surface and a back surface. Furthermore, the band has a top surface and a bottom surface. The band is a supple material being configured for being bendable. A first fold line is positioned proximate to the top surface of the band. The first fold line defines a first fold portion wherein the first fold line is configured for positioning the first fold portion perpendicular relative to the back surface of the band. Additionally, a second fold line is positioned proximate to the first fold line of the band. The second fold line defines a second fold portion wherein the second fold line is configured for positioning the second fold portion perpendicular relative to the back surface of the band and positioning the first fold portion parallel relative to the back surface the band. A strip is positioned on the front surface of the band. The strip is an adhesive material being configured for retaining a plurality of insects upon the strip by physical contact. The strip has a cover being removable from the strip.

Another embodiment of the disclosure includes a method comprising a step of bending a first fold portion of a band along a first fold line, thus positioning the first fold portion perpendicular relative to a back surface of the band. Subsequently, the user bends a second fold portion of the band along a second fold line, thus positioning the second fold portion perpendicular relative to the back surface of the band and the first fold portion is positioned parallel relative to the back surface of the band. The user inserts a trash bag within a trash bin prior to positioning an opening of the trash bag over a rim of the trash bin. The user nests the back surface of the band against an interior surface of the trash bin and inserting a cavity of the band upon the rim of the trash bin wherein retaining the band in place within the trash bin. The user removes a cover from the strip of the front surface of the band.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front isometric view of an insect seizing bin device and method according to an embodiment of the disclosure.

FIG. 2 is a detail isometric view of an embodiment of the disclosure.

FIG. 3 is a front view of an embodiment of the disclosure.

FIG. 4 is a rear view of an embodiment of the disclosure.

FIG. 5 is an in-use view of an embodiment of the disclosure.

FIG. 6 is an in-use view of an embodiment of the disclosure.

FIG. 7 is a cross-sectional view of an embodiment of the disclosure taken from FIG. 6 of Line 7-7.

FIG. 8 is a front isometric view of an alternate embodiment of the disclosure.

FIG. 9 is an in-use view of an alternate embodiment of the disclosure.

### DETAILED DESCRIPTION OF THE INVENTION

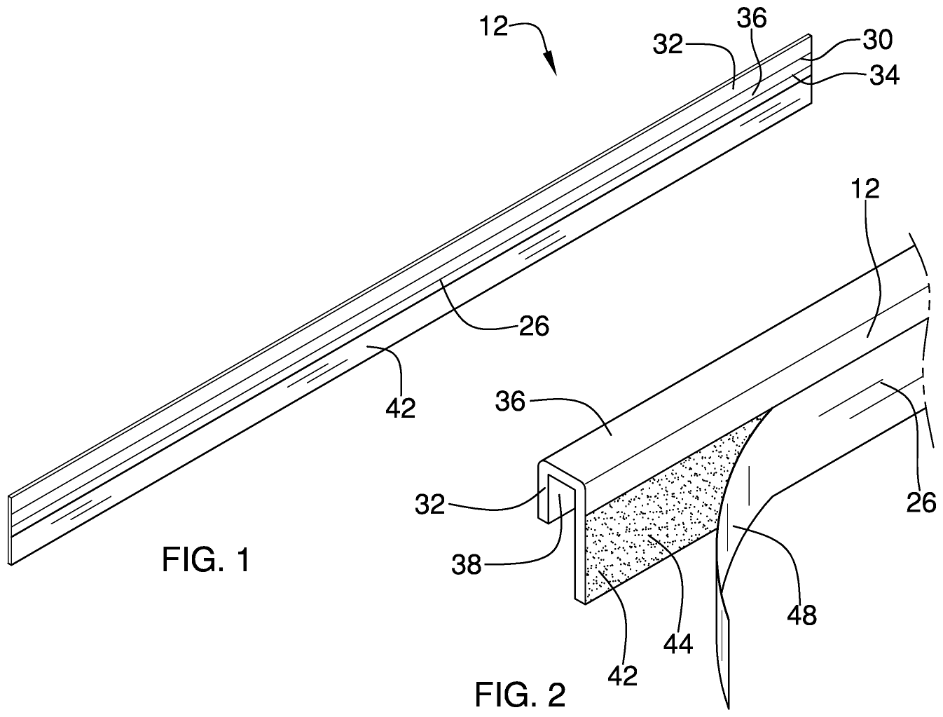

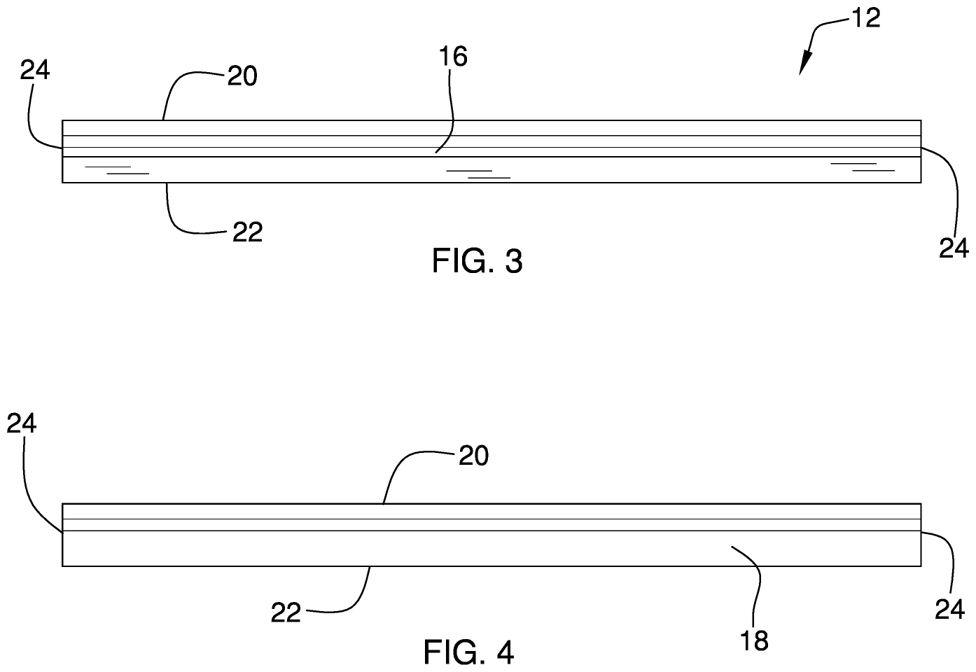

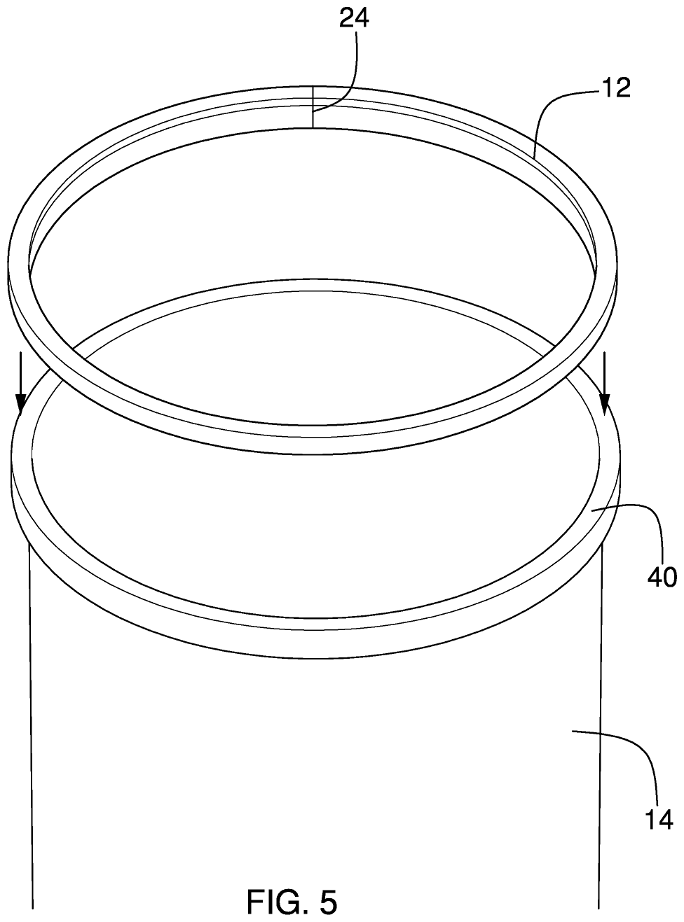

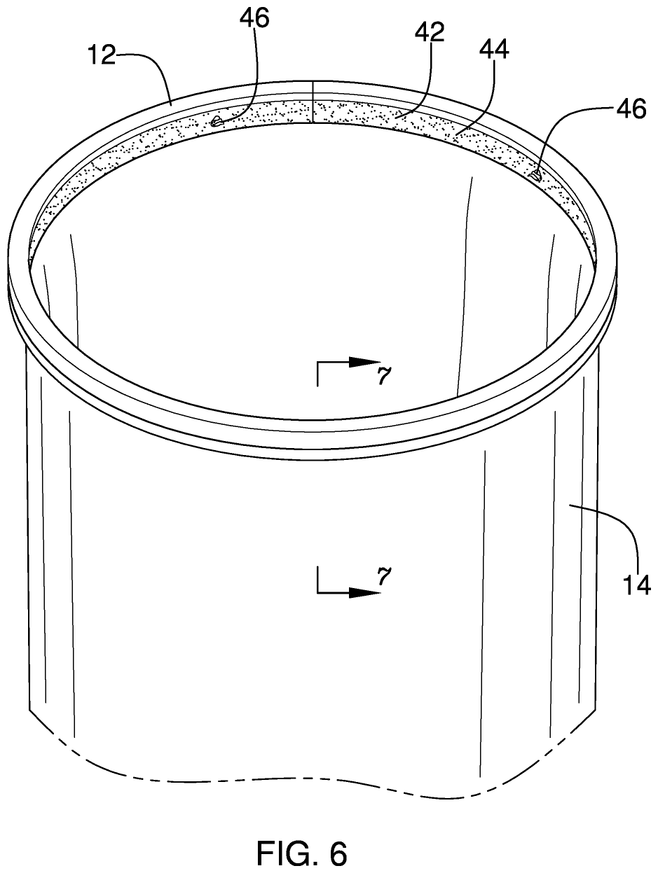

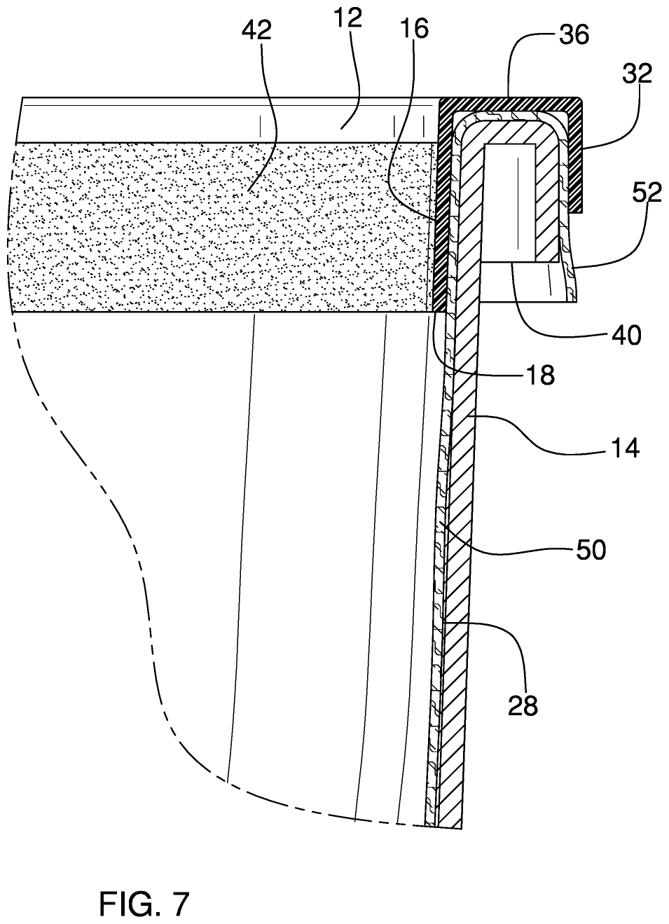

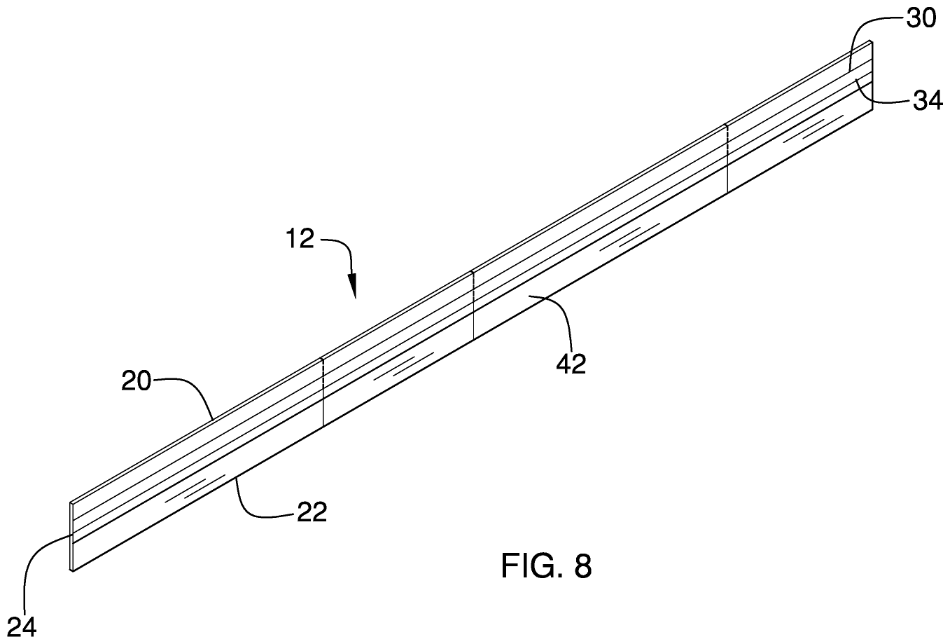

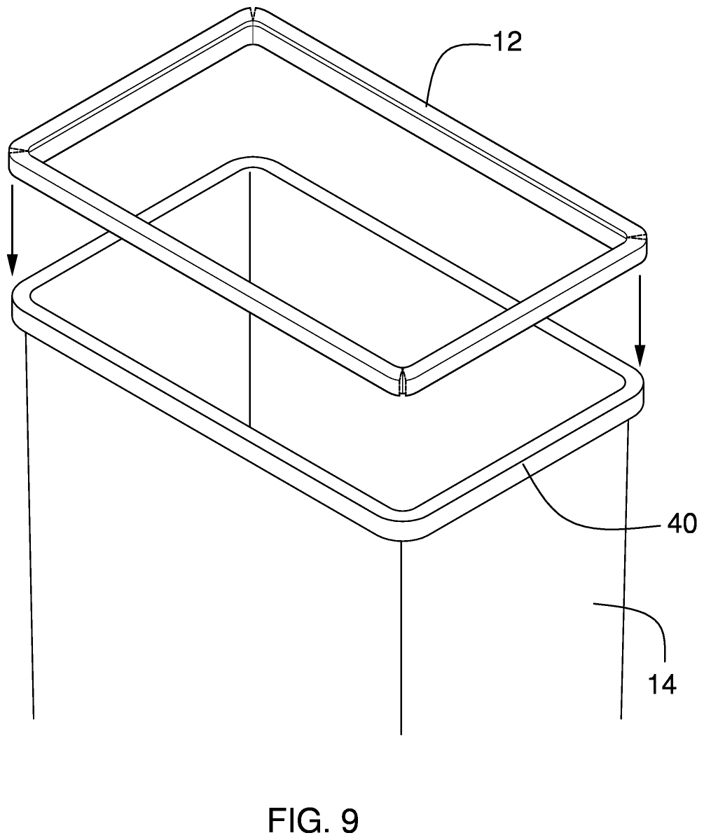

With reference now to the drawings, and in particular to FIGS. 1 through 9 thereof, a new insect seizing device embodying the principles and concepts of an embodiment of the disclosure and generally designated by the reference numeral 10 will be described.

As best illustrated in FIGS. 1 through 9, the insect seizing bin device and method 10 generally comprises a band 12. The band 12 has a rectangular shape and is configured for is elongated to a perimeter of a trash bin 14. The band 12 includes a front surface 16, a back surface 18, a top surface 20, a bottom surface 22, and a pair of end surfaces 24. The band 12 is a supple material 26 being configured for being bendable without fracturing. The band 12 is configured for bending to fit the shape of an interior surface 28 of the trash bin 14, thus the pair of end surfaces 24 is positioned abutting each other.

A first fold line 30 is positioned proximate to the top surface 20 of the band 12. Additionally, the first fold line 30 is positioned between each of the end surfaces 24 of the band 12. The first fold line 30 defines a first fold portion 32, thus the first fold line 30 is configured for positioning the first fold portion 32 perpendicular relative to the back surface 18 of the band 12. Furthermore, a second fold line 34 is positioned proximate to the first fold line 30 of the band 12. The second fold line 34 is positioned between each of the end surfaces 24 of the band 12. The second fold line 34 defines a second fold portion 36, thus the second fold line 34 is configured for positioning the second fold portion 36 perpendicular relative to the back surface 18 of the band 12 and positioning the first fold portion 32 parallel relative to the back surface 18 the band 12. Moreover, the first fold portion 32 and the second fold portion 36 define a cavity 38. The cavity 38 is configured for securing the band 12 to a rim 40 of the trash bin 14.

A strip 42 is positioned on the front surface 16 of the band 12. In addition, the strip 42 is positioned adjacent to the bottom surface 22 of the band 12. The strip 42 is an adhesive material 44 being configured for retaining a plurality of insects 46 upon the strip 42 by physical contact. The strip 42 has a cover 48 being positioned on the strip 42 wherein shielding the strip 42 prior to use. The cover 48 is removable from the strip 42 for use.

In use, the user bends the first fold portion 32 of the band 12 along the first fold line 30, thus positioning the first fold portion 32 perpendicular relative to the back surface 18 of the band 12. Subsequently, the user bends the second fold portion 36 of the band 12 along the second fold line 34, thus positioning the second fold portion 36 perpendicular relative to the back surface 18 of the band 12 and the first fold portion 32 positioned parallel relative to the back surface 18 of the band 12. The user inserts a trash bag 50 within the trash bin 14 prior to positioning an opening 52 of the trash bag 50 over the rim 40 of the trash bin 14. The user nests the back surface 18 of the band 12 against the interior surface 28 of the trash bin 14. Additionally, the user inserts the cavity 38 of the band 12 upon the rim 40 of the trash bin 14, thus retaining the band 12 in place within the trash bin 14. The user removes the cover 48 from the strip 42 of the front surface 16 of the band 12. The strip 42 will retain the plurality of insects 46 in a fixed position against the band 12 when each of the insects 46 comes in physical contact with the strip 42.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An insect seizing bin device configured for catching flies near a trash bin, the insect seizing bin device comprising:
a band having a rectangular shape, the band having a front surface and a back surface, the band having a top surface and a bottom surface, the band being a supple material, the supple material being configured for being bendable;
a first fold line being positioned proximate to the top surface of the band, the first fold line defining a first fold portion, the first fold line being configured for positioning the first fold portion perpendicular relative to the back surface of the band;
a second fold line being positioned proximate to the first fold line of the band, the second fold line defining a second fold portion, the second fold line being configured for positioning the second fold portion perpendicular relative to the back surface of the band;
wherein the band is positionable in a use configuration in which the first and second fold portions are oriented perpendicular to the back surface of the band and form a cavity therebetween, the cavity being sized such that the band is configured to mount to a rim of the trash bin by receiving the rim into the cavity when the band is in the use configuration, the band being configured to retain a trash bag against the rim of the trash bin when in the use configuration;
a strip being positioned on the front surface of the band, the strip being an adhesive material; and
a cover being positioned over the strip, the cover being configured to shield the strip from adhering to surfaces, the cover being removable from the strip.

2. The insect seizing bin device of claim 1, wherein the band is sized and configured for extending along an entirety of the rim of the trash bin.

3. (canceled)

4. The insect seizing bin device of claim 1, further comprising the band being configured for bending to fit the shape of an interior surface of the trash bin when the band is positioned in the use configuration, a pair of end surfaces of the band abutting each other when the band is positioned in the use configuration.

5. The insect seizing bin device of claim 4, wherein the first fold line extends between each of the end surfaces of the band.

6. The insect seizing bin device of claim 4, wherein the second fold line extends between each of the end surfaces of the band.

7. (canceled)

8. The insect seizing bin device of claim 1, wherein the strip is positioned adjacent to the bottom surface of the band.

9. (canceled)

10. An insect seizing bin device configured for catching flies near a trash bin, the insect seizing bin device comprising:
a band having a rectangular shape, the band being sized and configured for extending along an entirety of a rim of the trash bin, the band having a front surface and a back surface, the band having a top surface and a bottom surface, the band having a pair of end surfaces, the band being a supple material, the supple material being configured for being bendable;
a first fold line being positioned proximate to the top surface of the band, the first fold line extending between each of the end surfaces of the band, the first fold line defining a first fold portion, the first fold line being configured for positioning the first fold portion perpendicular relative to the back surface of the band;
a second fold line being positioned proximate to the first fold line of the band, the second fold line extending between each of the end surfaces of the band, the second fold line defining a second fold portion, the second fold line being configured for positioning the second fold portion perpendicular relative to the back surface of the band;
wherein the band is positionable in a use configuration in which the first and second fold portions are oriented perpendicular to the back surface of the band and form a cavity therebetween, the cavity being sized such that the band is configured to mount to a rim of the trash bin by receiving the rim into the cavity when the band is in the use configuration, the band being configured to retain a trash bag against the rim of the trash bin when in the use configuration;
a strip being positioned on the front surface of the band, the strip being positioned adjacent to the bottom surface of the band, the strip being an adhesive material, the adhesive material being configured for retaining a plurality of insects upon the strip by physical contact and
a cover being positioned over the strip, the cover being configured to shield the strip from adhering to surfaces, the cover being removable from the strip.

11. A method for removing snatching and removing insects from a bin, the method comprising a step of:
bending a first fold portion of a band along a first fold line;
positioning the first fold portion perpendicular relative to a back surface of the band;
bending a second fold portion of the band along a second fold line;
positioning the second fold portion perpendicular relative to the back surface of the band wherein the first fold portion being positioned parallel relative to the back surface of the band;
inserting a trash bag within a trash bin;
positioning an opening of the trash bag over a rim of the trash bin;
nesting the back surface of the band against an interior surface of the trash bin;
inserting a cavity of the band upon the rim of the trash bin wherein retaining the band in place within the trash bin; and
removing a cover from the strip of the front surface of the band.
